(19) United States
(12) Patent Application Publication
(10) Pub. No.: US 2011/0131332 A1
(43) Pub. Date: Jun. 2, 2011

(54) METHOD AND APPARATUS FOR TRANSFERRING A MEDIA SESSION

(75) Inventor: Imed Bouazizi, Tampere (FI)

(73) Assignee: NOKIA CORPORATION, Espoo (FI)

(21) Appl. No.: 12/787,223

(22) Filed: May 25, 2010

Related U.S. Application Data
(60) Provisional application No. 61/180,963, filed on May 26, 2009.

(51) Int. Cl. G06F 15/16

(52) U.S. Cl. 709/227

(57) ABSTRACT

Various methods for transferring a media session are provided. One example method includes triggering a media session transfer from a media receiver device, and providing a session transfer message to a network device. In this regard, the media receiver device and network device have communications connections to a network. Similar and related example methods and example apparatuses are also provided.

### RELATED APPLICATIONS

This application claims priority to U.S. Application Ser. No. 61/180963 filed 26 May 2009, which is incorporated herein by reference in its entirety.

### TECHNICAL FIELD

Embodiments of the present invention relate generally to mechanisms that present media content, and, more particularly, relate to a method and apparatus for transferring a media session from device to device.

### BACKGROUND

As network and mobile computing technologies continue to evolve, consumer demands for additional and more robust functionality continue to increase. Many mobile computing devices can present media content in the form of video, audio, and/or other formats. Users may prefer to use mobile devices for media content playback when in transit or otherwise away from the home or office. However, due to limitations of mobile devices, such as being small in size, users may prefer to have other devices present media content when available.

### BRIEF SUMMARY

According to example embodiments of the present invention, media session transferring is provided that allows the transfer of a media session from a media receiver device (e.g., a mobile terminal) to a target media receiver device (e.g., a television). In this regard, the media receiver device is a device that is currently presenting or was recently presenting media via a media session to a user. A triggering event initiates the transfer of the media session from the media receiver device to the target media receiver device. For example, the triggering event may be a user provided event (e.g., via a key press), a change in the current status of the media receiver device (e.g., a change in location), or a change in the devices that the media receiver device is currently detecting. In response to the triggering event, the media receiver device provides a session transfer message to a network device. The session transfer message may be provided as a Session Initiation Protocol (SIP) message via an Internet Protocol Multimedia Subsystem (IMS). The network device may be a server device implementing a Service Control Function (SCF) within the IMS. Based on the session transfer message, the network device facilitates establishing a transfer of the media session from the media receiver device to the target media receiver device by notifying the target media receiver device of the media session transfer.

Example embodiments of the present invention enable users to transfer IMS-based multimedia sessions from one device to another, and, in some example embodiments, the procedure for the user is simplified by sending the transfer message to a set of possible IMS devices. Example embodiments also enable flexibility on the time of transfer.

Various example embodiments of the present invention for transferring a media session are described herein. One example method comprises triggering a media session transfer from a media receiver device and providing a media session transfer message to a network device. The media receiver device and network device include communications connections to a network, such as an IMS network.

Another example method comprises receiving a media session transfer message from a media receiver device, and providing a notification message to facilitate establishing a media session at a target media receiver device based on the media session transfer message. The media session transfer message includes an identification of media content to be transferred.

Another example embodiment is an example apparatus for transferring a media session. The example apparatus comprises at least one processor and at least one memory including computer program code. The at least one memory and the computer program code may be configured to, with the at least one processor, cause the example apparatus or another apparatus to perform various functionality. For example, the example apparatus or the other apparatus may be caused to perform triggering a media session transfer from a media receiver device and providing a media session transfer message to a network device. The media receiver device and network device include communications connections to a network, such as an IMS network.

Another example embodiment is an example apparatus for transferring a media session. The example apparatus comprises at least one processor and at least one memory including computer program code. The at least one memory and the computer program code may be configured to, with the at least one processor, cause the example apparatus or another apparatus to perform various functionality. For example, the example apparatus or the other apparatus may be caused to perform receiving a media session transfer message from a media receiver device, and providing a notification message to facilitate establishing a media session at a target media receiver device based on the media session transfer message. The media session transfer message includes an identification of media content to be transferred.

Another example embodiment is an example computer program product for transferring a media session. The example computer program product comprises at least one computer-readable storage medium having executable computer-readable program code instructions stored therein. The computer-readable program code instructions of the example computer program product are for triggering a media session transfer from a media receiver device and providing a media session transfer message to a network device. The media receiver device and network device include communications connections to a network, such as an IMS network.

Another example embodiment is an example computer program product for transferring a media session. The example computer program product comprises at least one computer-readable storage medium having executable computer-readable program code instructions stored therein. The computer-readable program code instructions of the example computer program product are for receiving a media session transfer message from a media receiver device, and providing a notification message to facilitate establishing a media session at a target media receiver device based on the media session transfer message. The media session transfer message includes an identification of media content to be transferred.

Another example embodiment is an apparatus for transferring a media session. The example apparatus includes means for triggering a media session transfer from a media receiver device and means for providing a media session transfer message to a network device. The media receiver device and network device include communications connections to a network, such as an IMS network.

Another example embodiment is an apparatus for transferring a media session. The example apparatus includes means for receiving a media session transfer message from a media receiver device, and means for providing a notification message to facilitate establishing a media session at a target media receiver device based on the media session transfer message. The media session transfer message includes an identification of media content to be transferred.

### BRIEF DESCRIPTION OF THE DRAWING(S)

Having thus described the invention in general terms, reference will now be made to the accompanying drawings, which are not necessarily drawn to scale, and wherein:

FIG. 1 illustrates an IMS based system architecture according to various example embodiments of the present invention;

FIG. 2 illustrates an example media session transfer according to various example embodiments of the present invention;

FIG. 3 illustrates an example method for transferring a media session according to various example embodiments of the present invention;

FIG. 4 illustrates an example SUBSCRIBE message exchange according to various example embodiments of the present invention;

FIG. 5a illustrates a signaling diagram for transferring a media session according to various example embodiments of the present invention;

FIG. 5b illustrates another signaling diagram for transferring a media session according to various example embodiments of the present invention;

FIG. 6 illustrates an example system including example apparatuses for transferring a media session according to various example embodiments of the present invention;

FIG. 7a illustrates an example method for transferring a media session according to various example embodiments of the present invention;

FIG. 7b illustrates another example method for transferring a media session according to various example embodiments of the present invention; and

FIG. 8 illustrates a signaling diagram of a media session transfer according to various embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

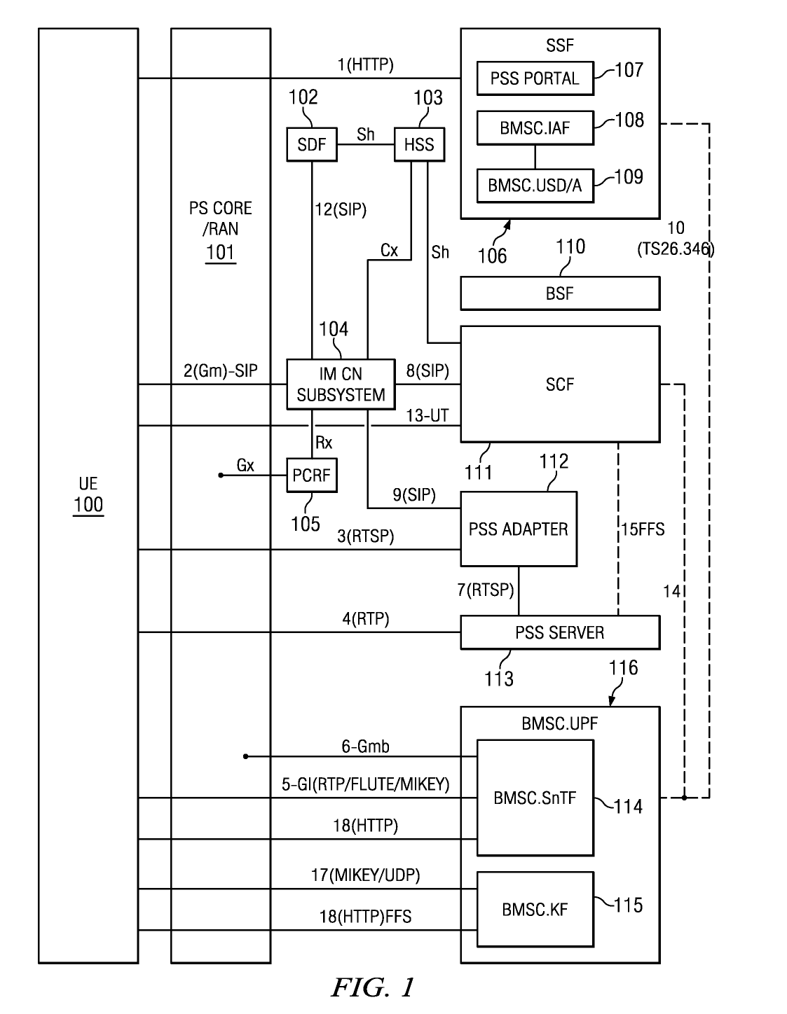

FIG. 1 illustrates an example Internet Protocol Multimedia Subsystem (IMS) architecture based on Internet Engineering Task Force (IETF) standards. The IMS architecture of FIG. 1 describes an IMS-based Packet Switched Streaming Service (PSS) and Multimedia Broadcast/Multicast Service (MBMS). The IMS architecture may provide a service platform that unifies different enablers for multimedia services, and simplifies the setup and management of the multimedia services. A main protocol in IMS is the Session Initiation Protocol (SIP), which may be used for the control and management of a multimedia session.

The IMS architecture of FIG. 1 may provide for various functionalities such as user registration, user authentication and authorization, resource reservation, policy control, interworking with circuit switched environments, and charging. These and other functionalities may be realized via numerous entities that comprise the IMS architecture.

The IMS architecture of FIG. 1 includes a User Equipment (UE) 100, a PS Core/RAN 101, an Service Discovery Function (SDF) 102, an Home Subscriber Server (HSS) 103, a IP Multimedia Core Network (IM CN) subsystem 104, a Policy and Charging Rules Function (PCRF) 105, a Service Selection Function (SSF) 106, a Packet-Switched Streaming Service (PSS) portal 107, a BMSC.IAF 108, a BMSC.USD/A 109, a Bootstrapping Server Function (BSF) 110, an Service Control Function (SCF) 111, a PSS adapter 112, a PSS Server 113, a BMSC.SnTF 114, a BMSC.KF 115, and a BMSC.UPF 116.

The User Equipment (UE) 100 may be a wireless communication device, such as mobile telephone or the like, that is capable of connecting to a packet switched network. A UE 100 may or may not be configured as an IMS device. The UE 100 may be configured to communicate with the SCF 111 using SIP messaging via the IM CN subsystem 104 (also referred to as the IMS core network 104). The IM CN subsystem 104 may include a plurality of sub-components, including a Calls/Session Control Function (CSCF), which may be a Proxy-CSCF (P-CSCF), an Interrogating-CSCF (I-CSCF), and/or a Serving-CSCF (S-CSCF). The IM CN subsystem 104 may also include an application server (AS), and/or a Media Resource Function (MRF).

The CSCF may be a SIP server that processes SIP messages in the IMS. In this regard, three different types of CSCF's may be utilized, namely the P-CSCF, the I-CSCF, and the S-CSCF. The P-CSCF may be the contact point between the IMS client (e.g., UE 101) and the IMS network. The I-CSCF may provide access to foreign IMS networks, and the S-CSCF may act as SIP registrar and serve the IMS client in its home network. An Application Server (AS) may be a SIP entity that hosts and executes IMS services (e.g., provides media content for playback) and the Media Resource Function (MRF) may provide the home network with media related functionalities.

A 3^{rd} Generation Partnership Project (3GPP) enhanced IMS network as depicted in FIG. 1 includes several functionalities to enable advanced IMS-based multimedia services. In this regard, the SDF 102 provides functionality for service discovery to the IMS terminal (e.g., UE 100). After service discovery, the IMS terminal may be directed to the SSF 106. The SSF 106 may provide a list of available user services that the IMS terminal is able to consume. The SSF 106 may perform other supporting functionality, such as personalization of the service list depending on the IMS terminal capabilities. The SSF 106 may also provide the service description information that will enable the user to start consuming the service.

The SCF 111 may provide functionality to support service realization, which includes service authorization at the start and during the lifetime of a media session. For example, the SCF 111 may support and/or control Internet Protocol Television (IPTV), mobile television, and other streaming services. The BSF 110 may perform bootstrapping functionality such as Generic Bootstrapping Architecture/ Authentication, Authorization, and Accounting (GBA/AAA) to authenticate and authorize the IMS terminal. The HSS 103 may contain an IMS user profile, as well as other user and IMS device related data (e.g., user preferences). The PCRF 105 may control functionality to perform charging and network resource allocation.

The PSS adapter 112 and a BMSC user plane sub-functions (BMSC.UPF) 116 may be defined to act as interfaces against the PSS and BMSC servers. The PSS adapter 112 may act as a proxy for PSS clients towards the PSS server 113. The PSS adapter may receive and process SIP and Real Time Streaming Protocol (RTSP) control messages from the UE 100. The PSS Server 113 may provide multimedia content to the UE 100 via streaming. The PS Core/RAN 101 may represent the network that handles (e.g., routes, polices, or the like) packet switched data communication of connected UEs 100. The PSS portal 107 is, in one embodiment, an entry point to PSS services, where a user may be able to browse and select content to be consumed in a streaming session from a PSS server 113.

A Broadcast Multicast Service Center (BM-SC) may provide multicast and broadcast services over 3GPP packet switched networks. The BMSC.IAF 108 may provide a subset of the BM-SC functionality. The BMSC.USD/A 109 may provide user service description and announcement functionality of the BM-SC. The BMSC.SnTF 114 may provide complementary service functionality for Multimedia Broadcast/Multicast Service (MBMS) services such as file repair and reception reporting. The BMSC.KF 115 may provide stream protection and key distribution functionality of the BM-SC and the BMSC.UPF 116 may contain BM-SC user plane sub-functions.

The IMS architecture of FIG. 1 may be further described based on the content of “IP Multimedia Subsystem (IMS) based Packet Switch Streaming (PSS) and Multimedia Broadcast/Multicast Service (MBMS) User Service; Protocols”, 3GPP TS 26.237, which specifies procedures to enable the consumption of streaming and multicast media services based on the IMS system and which is hereby incorporated by reference in its entirety.

For an IMS-based terminal (e.g., UE 100) to consume a PSS or MBMS service, the IMS terminal may first establish a network connection towards a cellular network. The terminal may then use the P-CSCF to identify the IMS core network 104, and perform an IMS registration with the identified IMS core network 104. Once registered, the terminal may connect to the SDF 102 to locate the SSF 106. After authentication with the BSF 110 and the SCF 111, the IMS terminal may connect to the SSF 106 to query a list of services and content that the terminal may consume or present.

Via the IMS architecture, users may therefore interchangeably use several devices with a static user identity. The IMS core network 104 may be configured to manage the connectivity details, such as the addressing of the various devices associated with the user identity, cross-device charging of the user, and the like. A user may therefore be available via any device registered with the IMS core network 104. According to various example embodiments, multimedia services benefit from this unified user identity by providing service continuity across many user devices.

As an example, a user consuming some Internet video content with a mobile terminal (e.g., UE 100) while entering the user's home environment may decide to continue watching the Internet video content on a television with IMS connectivity within the user's home for an improved user experience. Alternatively, a user may wish to resume watching the same content, where it left off on the mobile terminal, at later time. Further, the user may not have decided on which device the user wishes to use to continue watching the content (e.g., a media device in the kitchen or a media device in the living room). In this regard, in accordance with various example embodiments of the present invention, methods and apparatuses are provided that enable an easy and straightforward way for a user to select an appropriate target device and transfer the media session to the target device. In accordance with various example embodiments, methods and apparatuses are provided that utilize SIP messages via an IMS architecture to perform media session transfers from a media receiver device (e.g., a mobile terminal or other IMS connected device) to a target media receiver device (e.g., a television or other IMS connected device).

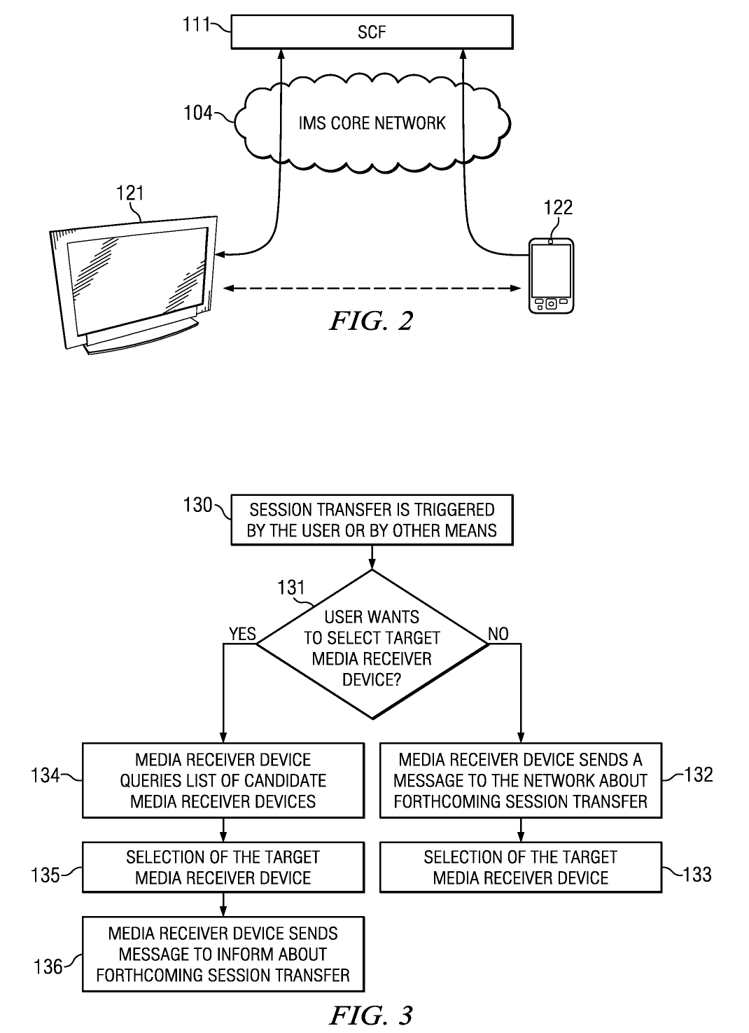

In this regard, FIG. 2 depicts an example media session transfer in accordance with one example embodiment of the present invention. The mobile device 122, which is configured as an IMS or SIP terminal similar to the UE 100 as described herein, is currently presenting media content via a media session to a user. The user may wish to transfer the media session from the mobile device 122 to the television 121, or a set-top box associated with the television, either of which is also configured as an IMS or SIP terminal similar to the UE 100 as described herein. As such, the mobile device 122, being the device that the media session is to be transferred from, is referred to as the media receiver device. Prior to selection of the television 121 for the media session transfer, the television 121 is referred to as a candidate media receiver device. According to one embodiment, a candidate media receiver device is an IMS or SIP configured device that is registered to a user's identity and is capable of presenting the media content to be transferred. Upon selection of the television 121 to receive the media session transfer, the television 121 is referred to as the target media receiver device. To perform the media session transfer, the mobile device 122 provides a media session transfer message to the SCF 111. The SCF 111, in turn, provides a notification message regarding the media session transfer to other network entities including the television 121, the target media receiver device. The television 121 may then establish a media session using information provided to the television 121 by the mobile device 122 via the SCF 111 (e.g., an identifier of the media content, a media playback bookmark, or the like). While this example describes a transfer of a media session from the mobile device 122 to the television 121, one of skill in the art would appreciate that a media session may be transferred from the television 121 to the mobile device 122, since both devices are configures to support and receive the transfer, as well as, initiate the transfer. As such, a media session transfer may occur between any two IMS or SIP-based as devices as described herein. For example, a transfer from the television 121 to the mobile device 122 may involve the user selecting a dedicated button on a remote control associated with the television 121 to transfer the media session to the mobile device 122.

FIG. 3 depicts an example flowchart describing an example method embodiment of the present invention. At 130, a session transfer is triggered. In this regard, the session transfer may be triggered in response to a triggering event. A triggering event may occur as a result of user interaction with a user interface (e.g., key press) of the media receiver device (the device from which the media session is to be transferred). Additionally, or alternatively, a triggering event may occur as a result of a change in status of the media receiver device. For example, a current geographic location of the media receiver device may be determined, and, upon determining that the current geographic location is within a threshold distance of a candidate media receiver device (e.g., the living room television, the computer in the den, the computer at work, or the like), a triggering event may occur. Further, a triggering event may occur when the media receiver device detects at least one nearby candidate media receiver device. For example, a candidate media receiver device may be configured to wirelessly communicate or ping nearby devices using, for example, Bluetooth communications. The media receiver device may receive communications in this regard from a candidate media receiver device and a triggering event may thereby occur. Additionally, a session transfer may be triggered when the media receiver device is anticipated not to be able to have the required resources for consuming the service or content to be transferred, for example, when the media receiver device is about to run out of power or when network connection is suffering from transmission errors or does not have sufficient bandwidth to support acceptable playback.

At 131, a determination is made as to whether a user of the media receiver device wishes to select a target media receiver device to receive the media session transfer or not. In one example embodiment, a user indicates a selection via a user interface of the media receiver device. If the user does not wish to make a selection to identify a target media receiver device, the media receiver device sends a message to the network about the forthcoming session transfer. In response, the network, or a network device implementing an SCF, notifies some or all of the candidate media receiver devices of the forthcoming or pending session transfer. At 133, a selection of the target media receiver device occurs. For example, a user may make a selection to identify the target media receiver device by powering up or activating the target media receiver device (e.g., turning on the television). Since the candidate media receiver devices were already aware of the forthcoming media session transfer, upon powering up or activation, the target media receiver device completes the session transfer and an optional confirmation of the target device by the user.

Alternatively, in one example embodiment, selection of the target media receiver device at 133 may be completed automatically. In this regard, the target media receiver device is selected based on the status of the media receiver device (e.g., the location being within a threshold distance, the detection of candidate media receiver devices) and/or a user defined priority for candidate media receiver devices. For example, if two candidate media receiver devices are detected, the user defined priority assigned to the candidate media receiver devices determines which device is the target media receiver device.

Referring again to the determination at 131, if the user wishes to select the target media receiver device, the receiver media device queries a list of candidate media receiver devices at 134. The list may be presented to the user together with supporting information (e.g. current location of the candidate media receiver devices). The user may then make a selection from the list to identify the target media receiver device at 135. Upon identifying the target media receiver device, the media receiver device sends a message to a network device and/or to the target media receiver device to facilitate transferring the media session to the target media receiver device.

To complete the media session transfer, the target media receiver device may query and present the notification message relating to the session transfer. The user may confirm the session transfer on the target media receiver device, and the target media receiver device may set up the transferred media session. The media session is transferred to the target media receiver device and the media content is presented on the media receiver device. Presentation of the media content may begin on the target media receiver device at the point in the playback of the media content where the media receiver device left off, at the point when triggering the transfer occurred, or at the selected point of time by the user. In this regard, the media receiver device may provide a media content playback bookmark indicating the location where playback ended, and the target media receiver device may receive and apply the media content playback bookmark to facilitate continuity of presentation between the devices for the user. According to one example embodiment, the media receiver device or the target media receiver device may receive an indication of a delay period from the user. In the event that the user wishes to have the target media receiver device present the transferred media content at a later time, the user may schedule the time for presentation using the user defined delay period.

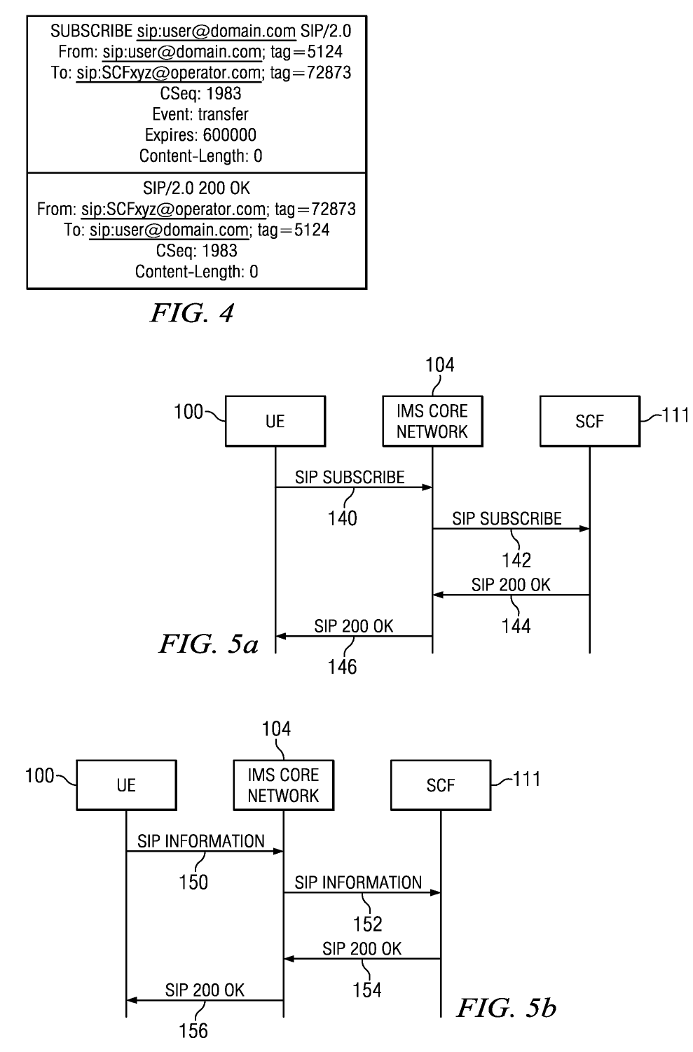

As mentioned above, in accordance with various example embodiments, SIP messaging may be used to implement a media session transfer. According to one example embodiment, a media receiver device registers as a candidate media receiver device for media session transfer by sending a SIP SUBSCRIBE message to the network, or more specifically to the SCF 111. In this regard, an event header field indicates an identification tag of the transfer event package, which, for example, may be set to “3gpp-Session-Transfer”. Alternatively, the event header field may indicate a generic event package and a body of the SUBSCRIBE message may include more specific information indicating a subscription for session transfer events. An example of a SIP SUBSCRIBE message exchange between a media source node and an SCF is depicted in FIG. 4. The message exchange of FIG. 4 includes the SIP SUBSCRIBE message and the response SIP/2.0200 OK message.

FIG. 5a illustrates a signaling diagram for the SIP SUBSCRIBE message exchange illustrated in FIG. 4. The UE 100 is operating as the target media receiver device and UE 100 provides a SIP SUBSCRIBE message to the IMS core network 104 to register for media session transfer events at 140. The IMS core network 104, in turn forwards the SIP SUBSCRIBE message to the SCF 111 at 142. In response, the SCF 111 provides a SIP 200 OK message at 144, and the IMS core network 104 relays the SIP 200 OK message to the UE 100 at 146.

Subsequent to registering for media session transfer events using the SIP SUBSCRIBE message, the UE 100 may initiate the session transfer procedure by providing further information about the session transfer to the SCF 111. In this regard, the media receiver device (e.g., UE 100) sends a message to the SCF 111 to inform about the forthcoming session transfer. The information within the message provides, for example, a media content identifier, the current position in the content (e.g., media content playback bookmark), the desired initiation time of the session transfer (e.g., based on a delay period), and/or a list of devices to be informed of the transfer. The information may be provided in SIP MESSAGE, SIP INFO, SIP OPTIONS, or SIP UPDATE message formats.

FIG. 5b illustrates a signaling diagram for a SIP INFO message exchange to provide information from a UE 100 operating as the media receiver device. The UE 100 provides a SIP INFO message to the IMS core network 104 to provide the information at 150. The IMS core network, in turn provides the SIP INFO message to the SCF 111 at 152. In response, the SCF 111 provides a SIP 200 OK message at 154, and the IMS core network 104 relays the SIP 200 OK message to the UE 100 at 156.

The payload of the SIP INFO message, or another information message, may include an Extensible Markup Language (XML) fragment that includes information about the requested session transfer. If the target media receiver device is to be determined automatically (without user selection), the message may include supporting information such as current location, required device capabilities for consuming the current service, and/or the like.

Additionally, the various devices (e.g., candidate media receiver devices) may be notified about the forthcoming media session transfer. Upon receiving a message from the media receiver device providing information about the desire to perform a session transfer, the SCF 111 may query a list of the candidate media receiver devices. The list may be compiled by identifying the devices that have subscribed to the session transfer event on behalf of the current user. Further, the candidate media receiver devices may be determined based on device capabilities, user preferences, the location of the devices, the detection of devices, and/or the user defined priority of the devices. A NOTIFY message may then be sent to some or all the candidate media receiver devices, based on a user selection and the candidate media receiver devices' status and/or availability.

Upon receiving a notification about a request to have the media session transferred to a target media receiver device, the target media receiver device may display a request for the user to confirm the session transfer. Once the user confirms the session transfer on the target media receiver device, the target media receiver device may confirm the session transfer to the SCF 111, and then establish a connection to an application server. The SCF 111 may also inform the media receiver device to trigger the media receiver device to tear down the existing media session, if tear down of the session has not yet occurred. The SCF 111 may also inform the candidate media receiver devices that the media session transfer is complete, to trigger the candidate media receiver devices to cancel any pending session transfer request.

As described above, in some example embodiments, a user may wish to select the target media receiver device from a list of candidate media receiver devices. To facilitate implementation of the selection by the user, the media receiver device sends a request to the SCF 111 to query a list of candidate media receiver devices. For example, the request is sent using SIP INFO or SIP OPTIONS messages. In response to the request, a list of candidate media receiver devices, that may have been compiled by filtering the list of registered user devices based on for example, the device's capability to consume the service, is received that the user may select from.

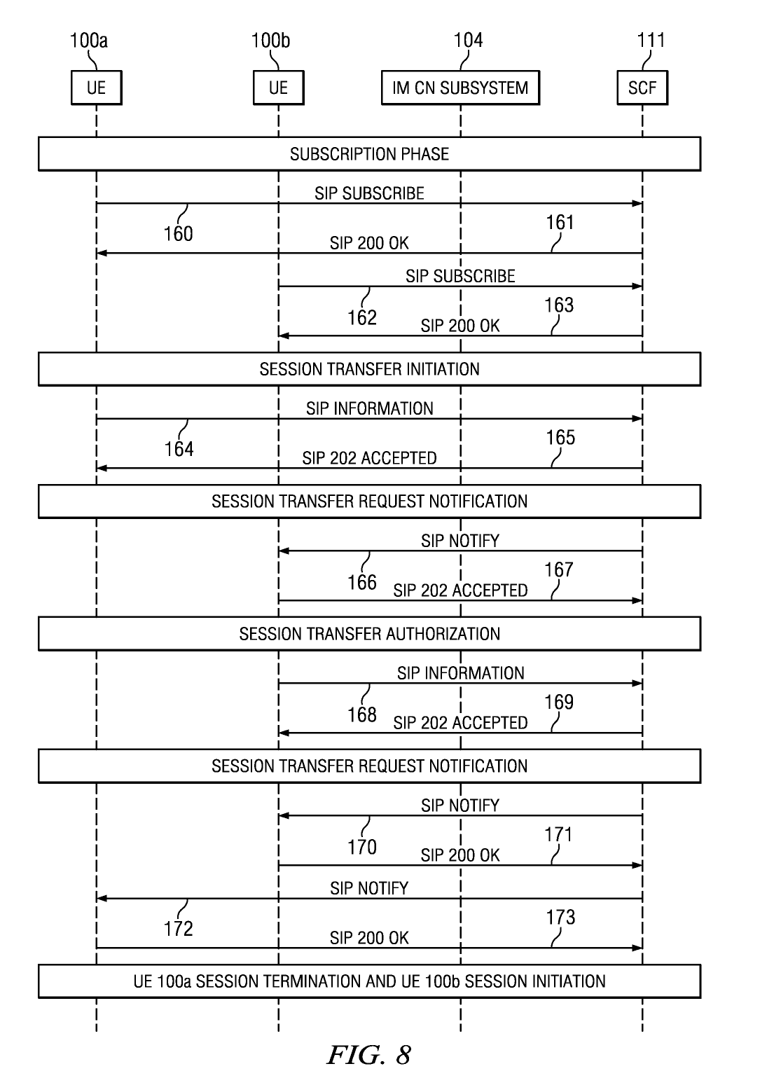

FIG. 8 depicts a signaling diagram for a media session transfer in accordance with various embodiments of the present invention. According to various embodiments, the event of transferring a media session may include three states, namely a triggered state, an unconfirmed state, and a completed state. The states may be further defined with respect to phases or sub-states. The signaling diagram of FIG. 8 provides detail regarding the various phases of the media session transfer, such as the subscription phase, session transfer initiation, session transfer request notification, session transfer authorization, session transfer request notification, and UE 100a session termination and UE 100b session initiation. In this regard, FIG. 8 includes the signaling and messages that are provided throughout the procedure between a UE 100a, a UE 100b, the IM CN subsystem 104, and the SCF 111. The UEs 100a and 100b may be configured in accordance with the UE 100 as described herein. In this example scenario of FIG. 8, UE 100a takes the role of the media receiver device (session transferring device) and the UE 100b takes the role of the target media receiver device (session receiving device).

According to various example embodiments, devices that support a media session transfer may be registered prior to the transfer event during a subscription phase. According to some example embodiments, registration of a device may be performed once for a particular device, and the device need not re-register unless the registration information is lost. A message used for registration may include information sufficient to authorize the device for session transfers related to the user. The message used for registration may also include a device profile description that may enable an SCF to evaluate whether the transferred session may be consumed by the device (e.g., the device is capable of supporting the session and the media content). During the subscription phase, at 160 and 162, UEs 100a and 100b, respectively, provide SIP SUBSCRIBE messages to generate and submit a subscription for notifications to the SCF 111 about transfer procedures related to a specific user. At 161 and 163, the subscription requests are accepted and acknowledged by the SCF 111 by providing SIP 200 OK messages.

Having subscribed the devices to the user at the SCF 111, a session transfer initiation may occur where the user of UE 100a decides to perform a session transfer from the UE 100a to the UE 100b, or a session transfer is automatically initiated between the devices as described herein. At 164, UE 100a generates and submits a SIP INFO message to the SCF 111 to inform the SCF 111 of the session transfer request. According to some example embodiments, the body of the SIP INFO message may formatted in XML and include information about the session to be transferred, such as the consumed content, an identifier of the consumed content, the position in the session (e.g., bookmark), a requested session transfer time, a selection of a set of candidate target devices, and/or combinations thereof. At 165, the SCF 111 confirms reception of the session transfer request with a SIP 202 ACCEPTED response.

Subsequently, the session transfer request notification phase may occur. In this regard, at 166, the SCF 111 notifies all or some of the subscribed user UEs (e.g., UE 100a and 100b) about the session transfer request using a SIP NOTIFY message. In some example embodiments, filtering criteria may be applied to a list of subscribed devices to limit the selection to one or more appropriate devices for receiving the transferred session. At 167, the subscribed UEs (e.g., UE 100b) acknowledge acceptance of the notification message by generating a submitting a SIP 202 ACCEPTED message. The SIP 202 ACCEPTED message indicates that no final acceptance has been granted. The UE 100b, having bee identified or selected to be the target media receiver device, may request user confirmation for the session transfer to the UE 100b for the user.

Session transfer authorization may then occur. At 168, upon user confirmation or automatic confirmation, UE 100b informs the SCF 111 about the accepted session transfer. At 169, the SCF 111 acknowledges the potential target for the session transfer with a SIP 202 ACCEPTED message to the UE 100b. An authorized session transfer may be confirmed in the response message and the state may be changed to “completed”. According to some example embodiments, the SCF 111 may enforce session transfer policies that, for example, restrict transfer to single device.

Session transfer request notification may then occur. At 170 and 172, the SCF 111 prioritizes and selects the final target device (e.g., UE 100b) for the session transfer, and the selection is confirmed by providing SIP NOTIFY messages to UE 100b and 100a, respectively, to indicate that the state of the session transfer operation is now set to “completed”. At 171 and 173, UEs 100b and 100a, respectively, confirm reception of the notification messages with SIP 200 OK messages. As a result, the non-selected candidate devices may cancel any local, pending confirmation requests and may consider the session transfer terminated.

The target device (e.g., UE 100b) may then initiate a new PSS or MBMS session using the appropriate setup procedures. The transferring device (e.g., UE 100a) may then terminate reception of the original session, for example by using the appropriate teardown procedure. Note that the UEs 100 may be configured to support a time delay for transferring the media session at a later time, in which case the transferring UE (e.g., EU 100a) terminates the session in advance of the new session being initiated at the target device (e.g., UE 100b). In this regard, the SCF 111, after the delay, may send the notification about the session transfer, possibly shortly before the requested session transfer time.

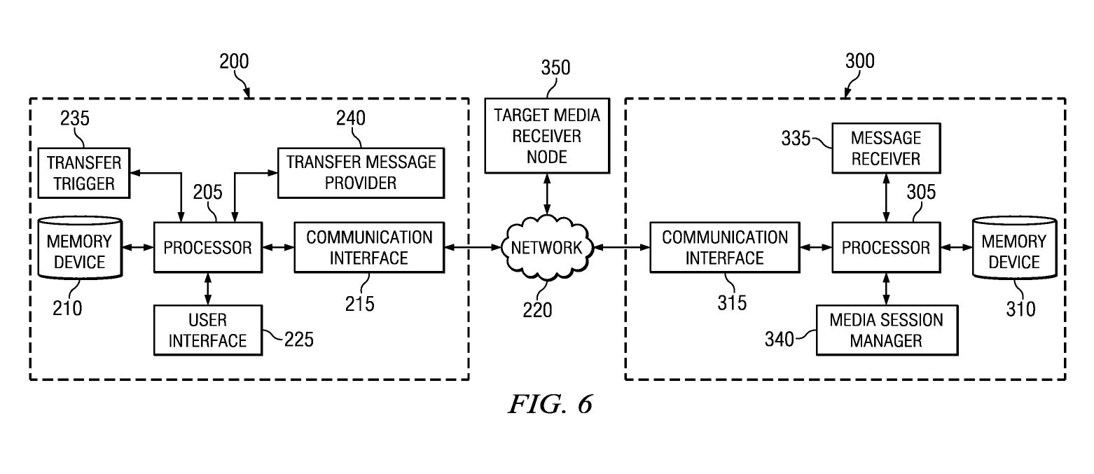

Referring now to FIG. 6, apparatuses 200 and 300 in accordance with example embodiments of the present invention are embodied as, or included as components of, communication devices with wired or wireless communications capabilities. According to various example embodiments, the apparatus 200 may be configured to operate in accordance with the UE 100 as described herein, and may be configured to perform the role of the media receiver device and/or the role of the target media receiver device described herein. The apparatus 300 is configured to perform the role of the network device (e.g., SCF 111) as described herein. The target media receiver device 350 is a communications device connected to the network 220, and the target media receiver device 350 is configured to receive and accept a media session transfer and present the associated media content to a user. As described above, the apparatus 200 may be configured to also be a target media receiver device, depending on the circumstances, as such, apparatus 200, and in particular processor 205 and memory 210, may be configured to implement and/or store instructions for implementing the operations described with respect to the target media receiver device as described herein.

In some example embodiments, the apparatus 200 may include or be included within a computer (e.g., network entity such as a network server), a media playback device, or a mobile terminal such as a mobile telephone, a portable digital assistant (PDA), a pager, a mobile television, a gaming device, a mobile computer, a laptop computer, a camera, a video recorder, an audio/video player, a radio, and/or a global positioning system (GPS) device, any combination of the aforementioned, or the like.

The example apparatus 200 includes or is otherwise in communication with a processor 205, a memory device 210, a communications interface 215, a transfer trigger 235, and a transfer message provider 240. In some embodiments, the example apparatus 200 may include a user interface 225. The processor 205 may be embodied as various means implementing various functionality of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors operating in concert. The processor 205 may, but need not, include one or more accompanying digital signal processors. In some example embodiments, the processor 205 is configured to execute instructions stored in the memory device 210 or instructions otherwise accessible to the processor 205. As such, whether configured as hardware or via instructions stored on a computer-readable storage medium, or by a combination thereof, the processor 205 may be an entity capable of performing operations according to embodiments of the present invention while configured accordingly. Thus, in example embodiments where the processor 205 is embodied as an ASIC, FPGA, or the like, the processor 205 is specifically configured hardware for conducting the operations described herein. Alternatively, in example embodiments where the processor 205 is embodied as an executor of instructions stored on a computer-readable storage medium, the instructions specifically configure the processor 205 to perform the algorithms and operations described herein. In some example embodiments, the processor 205 is a processor of a specific device (e.g., a mobile terminal) configured for employing example embodiments of the present invention by further configuration of the processor 205 via executed instructions for performing the algorithms and operations described herein.

The memory device 210 may be one or more computer-readable storage media that may comprise volatile and/or non-volatile memory. In some example embodiments, the memory device 210 comprises Random Access Memory (RAM) including dynamic and/or static RAM, on-chip or off-chip cache memory, and/or the like. Further, memory device 210 may comprise non-volatile memory, which may be embedded and/or removable, and may comprise, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may comprise a cache area for temporary storage of data. In this regard, some or all of memory device 210 may be included within the processor 205.

Further, the memory device 210 may be configured to store information, data, applications, computer-readable program code instructions, or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The communication interface 215 may be any device or means embodied in either hardware, a computer program product, or a combination of hardware and a computer program product that is configured to receive and/or transmit data from/to a network and/or any other device or module in communication with the example apparatus 200. Processor 205 may also be configured to facilitate communications via the communications interface by, for example, controlling hardware included within the communications interface 215. In this regard, the communication interface 215 may comprise, for example, one or more antennas, a transmitter, a receiver, a transceiver and/or supporting hardware, comprising a processor for enabling communications with network 220. Via the communication interface 215 and the network 220, the example apparatus 200 may communicate with various other network entities in a device-to-device fashion and/or via indirect communications via a base station, access point, server, gateway, router, or the like. According to various example embodiments, the network 220 may be, or at least include, an IMS core network.

The communications interface 215 may be configured to provide for communications in accordance with any wired or wireless communication standard or communications technique. For example, the communications interface may be configured to communication in accordance with Ethernet (e.g., IEEE 802.3), token ring, (e.g., IEEE 802.4, IEEE 802.5, or the like), Fiber Distributed Data Interface (FDDI), Synchronous Optical Network (SONET), or the like. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 215 may also be configured to support communications using SIP messages within an IMS core network.

Via the communications interface, the apparatus 200 may be configured to detect one or more candidate media receiver devices. In this regard, detection of a candidate media receiver device may occur when communications between the apparatus 200 and the candidate media receiver device have occurred. For example, the communications interface 215 may be configured to connect to or at least acknowledge the presence of a candidate media receiver device via Bluetooth or another protocol. A Bluetooth connection may indicate that the apparatus 200 and the candidate media receiver device are located in relatively close proximity. By connecting to or acknowledging the candidate media receiver device, the apparatus 200 may thereby detect the candidate media receiver device.

The user interface 225 may be in communication with the processor 205 to receive user input via the user interface 225 and/or to present output to a user as, for example, audible, visual, mechanical or other output indications. The user interface 225 may be configured to present media content to a user. The user interface 225 may comprise, for example, a keyboard, a mouse, a joystick, a display (e.g., a touch screen display), a microphone, a speaker, or other input/output mechanisms.

The apparatus 200 may also include a location sensor (not depicted). The location sensor may be configured to determine the geographic location of the apparatus 200 via Global Positioning System (GPS), triangulation, or any other locating technology. The location of the apparatus 200 may also be determined by other means. For example, the location of the apparatus 200 may be determined based on a network connection that has limited range. For example, the location of the apparatus 200 may be determined based on a connection to a Wi-Fi network having a known location (e.g., a home or work Wi-Fi network).

The transfer trigger 235 and/or the transfer message provider 240 of example apparatus 200 may be any means or device embodied, partially or wholly, in hardware, a computer program product, or a combination of hardware and a computer program product, such as processor 205 implementing stored instructions to configure the example apparatus 200, or a hardware configured processor 205, that is configured to carry out the functions of the transfer trigger 235 and/or the transfer message provider 240 as described herein. In an example embodiment, the processor 205 includes, or controls, the transfer trigger 235 and/or the transfer message provider 240. The transfer trigger 235 and/or the transfer message provider 240 may be, partially or wholly, embodied as processors similar to, but separate from processor 205. In this regard, the transfer trigger 235 and/or the transfer message provider 240 may be in communication with the processor 205. In various example embodiments, the transfer trigger 235 and/or the transfer message provider 240 may, partially or wholly, reside on differing apparatuses such that some or all of the functionality of the transfer trigger 235 and/or the transfer message provider 240 may be performed by a first apparatus, and the remainder of the functionality of the transfer trigger 235 and/or the transfer message provider 240 may be performed by one or more other apparatuses.

The transfer trigger 235 is configured to cause the apparatus 200 or another apparatus to perform various functionalities. The transfer trigger 235 may be configured to trigger a media session transfer. In this regard, the transfer trigger 235 identifies a triggering event. A triggering event may occur based on a current status or a change in status of the media receiver device. The triggering event may occur in response to a change in the location of the media receiver device, or the detection of a candidate media receiver device.

The transfer message provider 240 is configured to cause the apparatus 200 or another apparatus to perform various functionalities. The transfer message provider 240 is configured to provide a media session transfer message to a network device (e.g., apparatus 300). The transfer message provider 240 may be configured to provide the media session transfer message via the network 220. The media session transfer message may be a SIP message. In some example embodiments, the media session transfer message includes an identification of the media content to be transferred. According to one example embodiment, the transfer message provider 240 queries a list of one or more candidate media receiver devices. The list may be queried from a network device (e.g., apparatus 300). According to one example embodiment, the transfer message provider 240 is configured to receive a selection of a target media receiver device 350, where the target media receiver device 350 being one of the one or more candidate media receiver devices. According to another embodiment, the transfer message provider 240 is configured to provide a media session transfer message that includes an instruction to the network device, requesting that the network device notify one or more candidate media receiver devices of a pending media session transfer.

Referring now to the apparatus 300, the apparatus 300 may include or be included within a computer (e.g., network entity such as a network server), or a mobile terminal such as a mobile telephone, a portable digital assistant (PDA), a pager, a mobile television, a gaming device, a mobile computer, a laptop computer, a camera, a video recorder, an audio/video player, a radio, and/or a global positioning system (GPS) device, any combination of the aforementioned, or the like.

The example apparatus 300 includes or is otherwise in communication with a processor 305, a memory device 310, a communications interface 315, a message receiver 335, and a media session manager 340. In some embodiments, the example apparatus 300 may include a user interface, similar to the user interface 225. The processor 305 may be embodied as various means implementing various functionality of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 305 may be representative of a plurality of processors operating in concert. The processor 305 may, but need not, include one or more accompanying digital signal processors. In some example embodiments, the processor 305 is configured to execute instructions stored in the memory device 310 or instructions otherwise accessible to the processor 305. As such, whether configured as hardware or via instructions stored on a computer-readable storage medium, or by a combination thereof, the processor 305 may be an entity capable of performing operations according to embodiments of the present invention while configured accordingly. Thus, in example embodiments where the processor 305 is embodied as an ASIC, FPGA, or the like, the processor 305 is specifically configured hardware for conducting the operations described herein. Alternatively, in example embodiments where the processor 305 is embodied as an executor of instructions stored on a computer-readable storage medium, the instructions specifically configure the processor 305 to perform the algorithms and operations described herein. In some example embodiments, the processor 305 is a processor of a specific device (e.g., a mobile terminal) configured for employing example embodiments of the present invention by further configuration of the processor 305 via executed instructions for performing the algorithms and operations described herein.

The memory device 310 may be one or more computer-readable storage media that may comprise volatile and/or non-volatile memory. In some example embodiments, the memory device 310 comprises Random Access Memory (RAM) including dynamic and/or static RAM, on-chip or off-chip cache memory, and/or the like. Further, memory device 310 may comprise non-volatile memory, which may be embedded and/or removable, and may comprise, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 310 may comprise a cache area for temporary storage of data. In this regard, some or all of memory device 310 may be included within the processor 305.

Further, the memory device 310 may be configured to store information, data, applications, computer-readable program code instructions, or the like for enabling the processor 305 and the example apparatus 300 to carry out various functions in accordance with example embodiments of the present invention described herein. For example, the memory device 310 could be configured to buffer input data for processing by the processor 305. Additionally, or alternatively, the memory device 310 may be configured to store instructions for execution by the processor 305.

The communication interface 315 may be any device or means embodied in either hardware, a computer program product, or a combination of hardware and a computer program product that is configured to receive and/or transmit data from/to a network and/or any other device or module in communication with the example apparatus 300. Processor 305 may also be configured to facilitate communications via the communications interface by, for example, controlling hardware included within the communications interface 315. In this regard, the communication interface 315 may comprise, for example, one or more antennas, a transmitter, a receiver, a transceiver and/or supporting hardware, comprising a processor for enabling communications with network 220. Via the communication interface 315 and the network 220, the example apparatus 300 may communicate with various other network entities in a device-to-device fashion and/or via indirect communications via a base station, access point, server, gateway, router, or the like. According to various example embodiments, the network 220 may be, or at least include, an IMS core network.

The communications interface 315 may be configured to provide for communications in accordance with any wired or wireless communication standard or communications technique. For example, the communications interface may be configured to communication in accordance with Ethernet (e.g., IEEE 802.3), token ring, (e.g., IEEE 802.4, IEEE 802.5, or the like), Fiber Distributed Data Interface (FDDI), Synchronous Optical Network (SONET), or the like. The communications interface 315 may be configured to support communications in multiple antenna environments, such as multiple input multiple output (MIMO) environments. Further, the communications interface 315 may be configured to support orthogonal frequency division multiplexed (OFDM) signaling. In some example embodiments, the communications interface 315 may be configured to communicate in accordance with various techniques, such as, second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 315 may also be configured to support communications at the network layer, possibly via Internet Protocol (IP).

The message receiver 335 and/or the media session manager 340 of example apparatus 300 may be any means or device embodied, partially or wholly, in hardware, a computer program product, or a combination of hardware and a computer program product, such as processor 305 implementing stored instructions to configure the example apparatus 300, or a hardware configured processor 305, that is configured to carry out the functions of the message receiver 335 and/or the media session manager 340 as described herein. In an example embodiment, the processor 305 includes, or controls, the message receiver 335 and/or the media session manager 340. The message receiver 335 and/or the media session manager 340 may be, partially or wholly, embodied as processors similar to, but separate from processor 305. In this regard, the message receiver 335 and/or the media session manager 340 may be in communication with the processor 305. In various example embodiments, the message receiver 335 and/or the media session manager 340 may, partially or wholly, reside on differing apparatuses such that some or all of the functionality of the message receiver 335 and/or the media session manager 340 may be performed by a first apparatus, and the remainder of the functionality of the message receiver 335 and/or the media session manager 340 may be performed by one or more other apparatuses.

The message receiver 335 is configured to cause the apparatus 300 or another apparatus to perform various functionalities. The message receiver 335 may be configured to receive a media session transfer message from a media receiver device. The media session transfer message may include an identification of media content to be transferred. According to one example embodiment, the media session transfer message includes an indication of a selection of the target media receiver device 350 as a receiver for a media session transfer. Further, in accordance with one example embodiment, the message receiver 335 receives the media session transfer message via an IMS network. In this regard, the apparatus 300 and more particularly, the processor 305 implements an SCF as described above and generally herein. Further, the session transfer message may be a SIP message.

The media session manager 340 is configured to cause the apparatus 300 or another apparatus to perform various functionalities. The media session manager 340 may be configured to facilitate establishing a media session at a target media receiver device 350 based on the media session transfer message, for example by providing a notification message. To facilitate establishing the media session, the media session manager 340 may be configured to provide a SIP message to the target media receiver device 350 to establish the media session. The target media receiver device may, in response to the notification, begin a subscription procedure to establish a media session. Media content identified in the notification message may be presented by the target media receiver based on a media content identifier and, in some example embodiments, a media playback bookmark. According to one embodiment, the media session manager 340 is configured to provide a notification to one or more candidate media receiver devices to prepare the one or more candidate media receiver devices for a pending session transfer. In this regard, the one or more candidate media receiver devices may include the target media receiver device 350.

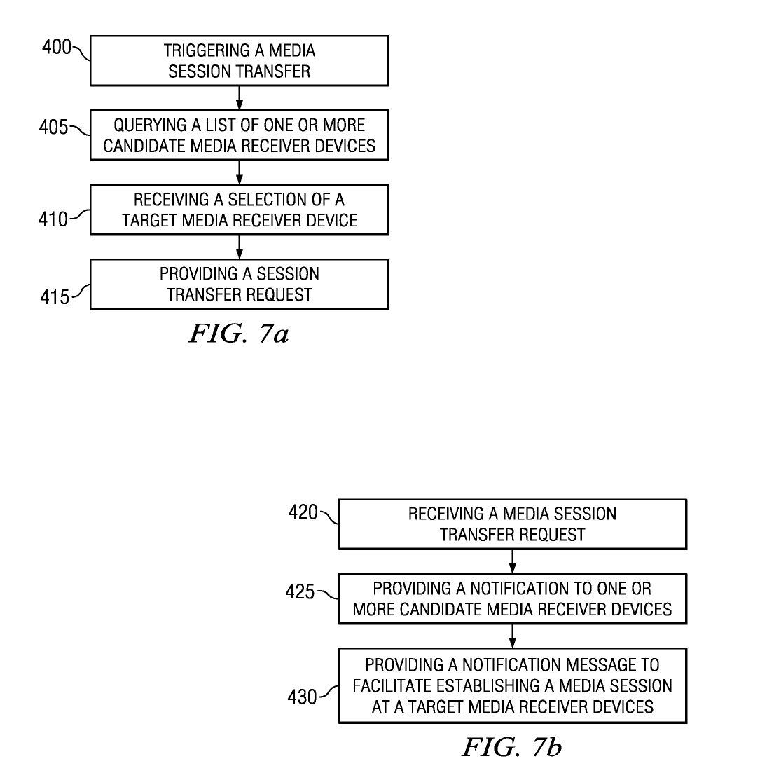

FIGS. 3, 4a, 4b, 7a, 7b, and 8 illustrate one or more flowcharts of example systems, methods, and/or computer program products according to example embodiments of the invention. It will be understood that each block or operation of the flowcharts, and/or combinations of blocks or operations in the flowcharts, can be implemented by various means. Means for implementing the blocks or operations of the flowcharts, combinations of the blocks or operations in the flowchart, or other functionality of example embodiments of the present invention described herein may comprise hardware, and/or a computer program product comprising a computer-readable storage medium having one or more computer program code instructions, program instructions, or executable computer-readable program code instructions stored therein. In this regard, program code instructions may be stored on a memory device, such as memory devices 210 and/or 310, of an example apparatus, such as example apparatus 200 or 300, and executed by a processor, such as the processor 205 or 305. As will be appreciated, any such program code instructions may be loaded onto a computer or other programmable apparatus (e.g., processors 205 or 305, memory devices 210 or 310) from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowchart by a processor, or storage of instructions associated with the blocks or operations of the flowcharts in a computer-readable storage medium, support combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

FIG. 6a depicts one or more flowcharts of example methods for transferring a media session. One example method comprises triggering a media session transfer at 400. In this regard, the media session transfer may be triggered in response to a triggering event. A triggering event may occur based on user input and/or a current status or a change in status of the media receiver device. The triggering event may occur in response to a change in the location or resource status of the media receiver device, or the detection of a candidate media receiver device.

According to one example embodiment, the example method includes providing a media session transfer message to a network device at 415. The media session transfer message may be provided via a network, such as and IMS core network. The session transfer message may be a SIP message, and may include an identification of the media content to be transferred.

Prior to providing the session transfer message, according to one example method, the method includes querying a list of one or more candidate media receiver devices at 405. The list may be queried from a network device (e.g., SCF 111). A selection of a target media receiver device is also be received at 410. The target media receiver device may be one of the one or more candidate media receiver devices. A session transfer message may include an instruction to a network device, requesting that the network device notify one or more candidate media receiver devices of a pending media session transfer.

FIG. 6a depicts one or more flowcharts of example methods for transferring a media session. One example method comprises receiving a media session transfer message from a media receiver device at 420. The media session transfer message may include an identification of media content to be transferred. According to one example embodiment, the media session transfer message includes an indication of a selection of the target media receiver device as a receiver for a media session transfer. Further, in accordance with one example embodiment, the media session transfer message is received via an IMS network at a network device implementing an SCF as described above and generally herein. Further, the session transfer message may be a SIP message.

The example method also includes facilitating the establishment of a media session at a target media receiver device based on the media session transfer message by providing a notification message at 430. To facilitate establishing the media session, a SIP message may be provided to the target media receiver device 350 to establish the media session. The target media receiver device may, in response to the notification, begin a subscription procedure to establish a media session. Media content identified in the notification message may be presented by the target media receiver based on a media content identifier and, in some example embodiments, a media playback bookmark. According to one embodiment, prior to establishing the media session, a notification is provided to one or more candidate media receiver devices to prepare the one or more candidate media receiver devices for a pending session transfer. In this regard, the one or more candidate media receiver devices may include the target media receiver device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
triggering a media session transfer, wherein the media session transfer being a transfer of a media session from a media receiver device to a target media receiver device; and
providing a media session transfer message to a network device, wherein the media receiver device and network device have communications connections to a network.

2. The method of claim 1, wherein the media session transfer message comprises an identification of media content to be transferred.

3. The method of claim 2 further comprising:
querying a list of one or more candidate media receiver devices, the one or more candidate media receiver devices being configured to accept a media session transfer;
receiving a selection of a target media receiver device, the target media receiver device being one of the one or more candidate media receiver devices

4. The method of claim 1, wherein the media session transfer message comprises an instruction to the network device to notify one or more candidate media receiver devices of a pending media session transfer.

5. The method of claim 1, wherein providing the media session transfer message comprises providing the media session transfer message to the network device via an Internet Protocol Multimedia Subsystem network, the network device being a device implementing a Service Control Function, and the media session transfer message being a Session Initiation Protocol message.

6. The method of claim 2 further comprising at least one of:
determining a target media receiver device based on a user defined receiver device priority and a current status of the media receiver device;
determining a target media receiver device based on a current location of the media receiver device; and
determining a target media receiver device in response to detecting a candidate media receiver device.

7. An apparatus comprising at least one processor and at least one memory including computer program code, the at least one memory and the computer program code configured to, with the at least one processor, cause the apparatus to perform at least the following:
trigger a media session transfer, wherein the media session transfer being a transfer of a media session from a media receiver device to a target media receiver device; and
provide a media session transfer message to a network device, wherein the media receiver device and network device have communications connections to a network.

8. The apparatus of claim 7, wherein said media session transfer message comprises an identification of media content to be transferred.

9. The apparatus of claim 8, wherein the apparatus is further caused to perform at least the following:
query a list of one or more candidate media receiver devices, the one or more candidate media receiver devices being configured to accept a media session transfer; and
receive a selection of a target media receiver device, the target media receiver device being one of the one or more candidate media receiver devices.

10. The apparatus of claim 7, wherein the media session transfer message comprises an instruction to the network device to notify one or more candidate media receiver devices of a pending media session transfer.

11. The apparatus of claim 7, wherein the apparatus provides the media session transfer message to the network device via an Internet Protocol Multimedia Subsystem network, the network device being a device implementing a Service Control Function, and the media session transfer message being a Session Initiation Protocol message.

12. The apparatus of claim 8, wherein the apparatus is further caused to perform at least one of the following:
determine a target media receiver device based on a user defined receiver device priority and a current status of the media receiver device;
determine a target media receiver device based on a user defined receiver device priority and a current location of the media receiver device; and
determine a target media receiver device in response to detecting candidate media receiver device.

13. The apparatus of claim 7, wherein the apparatus comprises a mobile terminal.

14. A computer program product comprising at least one computer-readable storage medium having executable computer-readable program code instructions stored therein, the computer-readable program code instructions when executed cause an apparatus to perform the method according to claim 1.

15. A method comprising:
receiving, at a network device, a media session transfer message, wherein the media session transfer being a transfer of a media session from a media receiver device to a target media receiver device, the media session transfer message comprises an identification of media content to be transferred; and
providing a notification message to facilitate establishing a media session at the target media receiver device based on the media session transfer message.

16. The method of claim 15, wherein the media session transfer message comprises an indication of a selection of the target media receiver device as a destination for a media session transfer.

17. The method of claim 15, wherein providing the notification message comprises providing the notification to one or more candidate media receiver devices to prepare the one or more candidate media receiver devices for a pending session transfer, the one or more candidate media receiver devices comprise the target media receiver device.

18. The method of claim 15 wherein receiving the media session transfer message comprises receiving the media session transfer message via an Internet Protocol Multimedia Subsystem network at a network device implementing a Service Control Function, the session transfer message being a Session Initiation Protocol message.

19. The method of claim 15 wherein establishing a media session at a target media receiver device comprises providing a Session Initiation Protocol message to the target media receiver device to establish the media session.

20. An apparatus comprising at least one processor and at least one memory including computer program code, the at least one memory and the computer program code configured to, with the at least one processor, cause the apparatus to perform at least the following:
receiving a media session transfer message from a media receiver device, the media session transfer message including an identification of media content to be transferred; and
providing a notification message to facilitate establishing a media session at a target media receiver device based on the media session transfer message.

21. The apparatus of claim 20, wherein the media session transfer message comprises an indication of a selection of the target media receiver device as a receiver for a media session transfer.

22. The apparatus of claim 20, wherein the apparatus being caused to provide the notification message to one or more candidate media receiver devices to prepare the one or more candidate media receiver devices for a pending session transfer, the one or more candidate media receiver devices including the target media receiver device.

23. The apparatus of claim 20, wherein the apparatus receives the media session transfer message includes receiving the media session transfer message via an Internet Protocol Multimedia Subsystem network at a network device implementing a Service Control Function, the session transfer message being a Session Initiation Protocol message.

24. The apparatus of claim 20, wherein the apparatus being caused to provide a Session Initiation Protocol message to the target media receiver device to establish the media session.

25. The apparatus of claim 20, wherein the apparatus comprises a network server.

26. A computer program product comprising at least one computer-readable storage medium having executable computer-readable program code instructions stored therein, the computer-readable program code instructions when executed cause an apparatus to perform the method according to claim 15.
